(19) United States
(12) Patent Application Publication
(10) Pub. No.: US 2025/0114869 A1
(43) Pub. Date: Apr. 10, 2025

(54) LASER NANOSTRUCTURING FOR HIGHLY TRANSPARENT ANTI-FOGGING GLASS

(71) Applicant: Biomimetic Private Company, Heraklion, Crete (GR)

(72) Inventors: Evangelos Skoulas, Heraklion, Crete (GR); Antonis Papadopoulos, Heraklion, Crete (GR); Andreas Lemonis, Heraklion, Greece (GR); Emmanouil Stratakis, Heraklion, Crete (GR); Alexandros Mimidis, Heraklion, Crete (GR)

(73) Assignee: Biomimetic Private Company, Heraklion, Crete (GR)

(21) Appl. No.: 18/567,666

(22) PCT Filed: May 12, 2022
(86) PCT No.: PCT/GR2022/000027

§ 371 Date: Dec. 6, 2023

(30) Foreign Application Priority Data
Jun. 7, 2021 (GR) 20210100373

(51) Int. Cl. B23K 26/352; C03C 23/00

(52) U.S. Cl. CPC B23K 26/355; C03C 23/0025

(57) ABSTRACT

A method is disclosed for the use of lasers to realize stable super-hydrophilicity in transparent in the visible spectrum solid surfaces, coatings and devices employing transparent in the visible spectrum solids and ultrashort laser pulses. The lasers are used to shape surfaces of the transparent solid materials and generate a desired nanostructure pattern on the surfaces without affecting, contrariwise enhancing the transmissivity of the material, resulting in acquired anti-fogging properties under high humidity environments. More specifically the methods and devices for creating stable anti-fog effects of transparent in the visible solids as well as the devices employing laser nanotextured, transparent in the visible, solids, are disclosed.

### BACKGROUND

Super-hydrophilic/anti-fog coatings on transparent solids are used to improve visibility under humid environment or to enhance the performance of transparent media, for optoelectronic and electro-optical devices. Coatings suitable for this purpose are those that decrease the contact angle of water droplets formed on the surface due to surrounding humidity, sufficiently to form a thin water layer. This thin water layer due to its surface shape homogeneity compared to water droplets leads to reduced blur over a broad spectral range of light.

Anti-fog coatings can be formed upon coating the surface of a transparent solid of interest by applying a sequence of chemical compounds to form one or more thin layers on top of the transparent material. As a result, the coated surfaces exhibit increased wettability due to hydrophilic chemical groups that have been selected to terminate the surface. The use of hydrophilic chemical coatings can potentially harm the environment, due to the chemical wastes produced from manufacturing or application. Furthermore, chemical coating lack in stability against time, which can eventually cause degradation of its performance, even complete failure of its functionality under harsh environmental conditions. Last but not least, hydrophilic coatings may adversely affect the optical properties of the transparent to the visible substrate in non-humid conditions. Adverse effects include but are not limited to translucency and coloration.

### SUMMARY

The objective of this invention is to provide a simple and efficient method of producing super-hydrophilic surfaces on transparent to the visible spectrum solid materials, without affecting or even enhancing the transparent to the visible substrates' transmissivity. By processing transparent to the visible solids with lasers, periodical nanostructures can be produced on the surface, resulting to the enhancement of surface roughness leading to a hydrophilic surface with anti-fogging properties. The proposed technique is a single-step process which can be easily integrated to the industry using high-power and repeatability industrial laser sources.

In principle, a method of shaping a surface of a glassy material in order to attain super-hydrophilicity and anti-fogging properties is disclosed. The method comprises providing the transparent in the visible spectrum solid material on a holder; The method may alternatively employ an additional heat dissipating layer on the transparent to the visible solid surface that can absorb excess heat induced from the laser beam impinging the transparent solid; identifying a desired target nanostructure anti-fogging pattern on the surface of the transparent solid material; identifying a desired focus spot distribution on the surface of the transparent in the visible solid material; identifying a melting temperature of the transparent in the visible solid material; selecting a laser fluence value from a range of laser fluence values; selecting a wavelength, a pulse duration and repetition rate of laser pulses, from a range of wavelengths, repetition rates and pulse durations, respectively; selecting a number of consecutive laser pulses applied per focus spot on the laser surface; exposing the surface of the transparent in the visible solid material to a focused laser radiation with the selected wavelength, repetition rate, pulse duration and number of consecutive laser pulses to raise the temperature of the transparent material to around the melting temperature to shape at least a part of the surface and generate at least part of the desired target nanostructure pattern; relatively translating the transparent solid material relative to the laser beam, causing the beam to scan its surface and generate the desired nanostructure pattern on the whole surface of the transparent solid.

By processing the transparent solid surfaces with laser pulses self-assembled nanostructures may be formed. The formation of these structures results in the increase of surface roughness compared to the initial planar one while due to the tiny scale of the structures transparency in the visible spectrum is sustained. For example, glass surfaces are naturally hydrophilic since such surfaces are terminated by hydrophilic groups, including Hydroxyls and metallic oxides. These chemical species interact strongly with water due to their inherent polarity where the minimization of total system free energy leads to the spreading of a water droplet that may touch their surface reducing the droplet contact angle. Therefore, by increasing the surface roughness of an already hydrophilic material the hydrophilicity is also enhanced according to the well-known Wenzel model.

In some examples, the surface of the transparent to the visible solid material is exposed to a focused polarized laser radiation. Upon irradiation of transparent solids with a polarized laser beam, nano-structures may be formed in all directions within a—Gaussian-focus spot, which eventually leads to texturing of the treated surface with nano-spikes. Nano-structures can be pseudo-periodic and randomly distributed along the surface. Such surface nanotexturing significantly increases the surface area, enhances the hydrophilicity and therefore leads to anti-fogging properties. In some examples it may also simultaneously lead to increased transparency and antireflection properties

In some examples, identifying a desired focused pulse number receptive on the surface of the transparent solid material may comprise identifying an overlap by a preselected percentage of neighboring focus spots. The preselected overlap percentage may be 99.9% or lower.

In some examples, the method may further comprise scanning and/or rastering the laser beam on a stationary transparent solid material. By scanning with multiple scans in high-speed applying a small number of pulses (e.g., three to five) per pass the material melts and resolidifies creating a very small surface roughness without any structural formation. The scanning step may be set near to the spot diameter.

In some examples, the transparent solid material may comprise at least a glass piece. The glass piece may be on an electronic device. The electronic device may include a solar cell (SC), an automotive display, an electronic screen, a light emitting diode (LED) and/or a Light Detection and Ranging (LIDAR) sensor.

In some examples, the wavelength of the incident beam may be selected from 100 nm to 6100 nm. This may depend on the material to be shaped and the desired targeted features of the nanotexture pattern.

In some examples, the laser fluence or peak fluence may be selected in a range of 12 J/cm² to 0.2 J/cm². The repetition rate of the laser pulses may be of any value and the pulse duration may be selected up to 800 ps. The combination of these parameters may depend on the features of the nanostructures to be formed and the melting point of the material.

In another aspect, a manufacturing configuration to shape a surface of a transparent to visible solid material to achieve anti-fogging properties is disclosed. The manufacturing configuration may integrate a pulsed laser source and an optical system for focusing the beam emitted from the pulsed laser source. The manufacturing configuration may further comprise a holder configured to hold the transparent solid material. The manufacturing configuration may also comprise a controller to: set a laser fluence value from a range of laser fluence values; set a laser pulse wavelength, a laser pulse repetition rate and a laser pulse duration from a range of laser pulse wavelengths, repetition rates and durations, respectively; set a number of consecutive laser pulses applied per focused laser spot on the surface; and set a relative translation sequence between the transparent solid material and the laser beam from the pulsed laser source to scan the transparent material surface and generate a desired nanostructure pattern.

In some examples, the optical system may comprise at least a mirror to direct the laser beam from the pulsed laser source to the transparent solid material and a focusing optical element to concentrate the laser beam on the transparent solid material.

In some examples, the pulsed laser source may be a picosecond or a femtosecond laser source.

In some examples, a translation module may be used to displace the transparent solid material holder, while the irradiation module remains stationary. In other examples, the optical system may be configured to displace the laser beam while the transparent solid material holder remains stationary. In yet other examples, a translation module may be configured to displace the irradiation module while the transparent solid material holder remains stationary.

In another aspect, an anti-fogging transparent to the visible solid material is disclosed. Also, the use of any additional material layer deposited on the surface of the solid material prior to the laser treatment. The additional layer could act as heat absorber and thus be removed by the laser beam during irradiation, leading again to nano-structuring of the solid surface. The anti-fogging transparent solid material may be shaped using a method of shaping according to examples disclosed herein and the additional heat-absorbing layer may be a common paint, ink, dye, metallic paint, etc.

In yet another aspect, the anti-fogging transparent to the visible solid material may be shaped using a method of shaping according to examples disclosed herein with the additional use of a secondary thermal or optical heating source during irradiation.

In yet another aspect, a device is disclosed. The device may comprise an anti-fogging transparent solid material according to examples disclosed herein.

In yet another aspect, a system for shaping a surface of a transparent to visible solid material to achieve anti-fogging properties and at the same time to reduce reflection from a surface of a transparent material is disclosed. The system may comprise means for providing the transparent to visible solid material on a holder; means of depositing a heat absorbing layer onto the transparent solid surface; means for identifying a desired target nanostructure anti-fogging pattern on the surface of the transparent solid material; means for identifying a desired focus spot distribution on the surface of the transparent solid material; means for identifying a melting temperature of the transparent solid material; means for setting a laser fluence value from a range of laser fluence values; means for setting a wavelength, a repetition rate and a pulse duration of a laser pulse, from a range of wavelengths, repetition rates and pulse durations, respectively; means for setting a number of consecutive laser pulses applied per focus spot on the laser surface; means for exposing the surface of the transparent solid material to a focused laser radiation with the selected wavelength, repetition rate, pulse duration and number of consecutive laser pulses to raise the temperature of the transparent material to around the melting temperature to shape at least a part of the surface and generate at least part of the desired target nanostructure pattern; means for relatively translating the transparent solid material to generate the desired nanostructure pattern.

In yet another aspect, a non-transitory computer program product that causes an irradiation configuration to perform shaping a surface of a transparent solid material is disclosed. The non-transitory computer program product may have instructions to: provide the transparent solid material on a holder; identify a desired target nanostructure anti-fogging pattern on the surface of the transparent solid material; identify a desired focus spot distribution on the surface of the transparent solid material; identify a melting temperature of the transparent solid material; select a laser fluence value from a range of laser fluence values; select a wavelength, a repetition rate and a pulse duration of a laser pulse from a range of wavelengths, repetition rates and pulse durations, respectively; select a number of consecutive laser pulses applied per focus spot on the laser surface; expose the surface of the transparent solid material to a focused laser radiation with the selected wavelength, repetition rate, pulse duration and number of consecutive laser pulses to raise the temperature of the transparent material to around the melting temperature to shape at least a part of the surface and generate at least part of the desired target nanostructure pattern; relatively translate the transparent solid material or the laser beam to generate the desired nanostructure pattern.

In yet another aspect, a computer program product is disclosed. The computer program product may comprise program instructions for causing an irradiation configuration to perform a method of shaping a surface of a transparent in the visible solid material according to examples disclosed herein.

The computer program product may be embodied on a storage medium (for example, a CD-ROM, a DVD, a USB stick, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the processes. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or other device or means.

Alternatively, the carrier may be an integrated circuit in which the computer program is embedded, the integrated circuit being adapted for performing, or for use in the performance of, the relevant methods.

### BRIEF DESCRIPTION OF THE DRAWINGS

Non-limiting examples of the present disclosure will be described in the following, with reference to the appended drawings, in which:

FIG. 1 schematically illustrates an evolution of nano-structure formation after laser irradiation, according to method 1 on bare glass and method 2 with the additional heat absorbing layer as examples.

FIG. 2 presents schematic illustration and actual image of the glass hydrophilicity and anti-fogging effect under misty environment.

FIG. 3 presents contact angle measurements over time for two representative glass types as well as transmittance measurements on the bare and laser nanostructured surfaces.

### DETAILED DESCRIPTION OF EXAMPLES

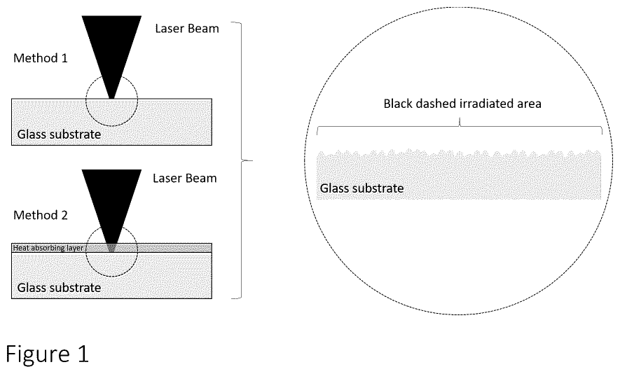

FIG. 1 schematically illustrates an evolution of nano-structure formation after single or multiple scans, according to methods 1 and 2. For method 1 ultrafast laser pulses irradiate a transparent in the visible solid. The irradiation conditions may vary depending on the material type and the overall process can be achieved in single or multiple laser scans. For method 2 the additional layer may be roughly deposited on the glass surface before the irradiation and can act as heat dissipation layer for homogenous nano-structuring of the glass surface. The nature of the additional layer can be either metallic or organic (i.e, a metallic paint, black matrix, ink, powder) and its thickness is irrelevant to the whole procedure given that it will eventually be ablated from the laser pulses. Upon the complete removal of the layer with the laser the glass surface below will be morphologically altered with nano-structures. The use of the additional layer is optional and may be used only on specific types of glasses.

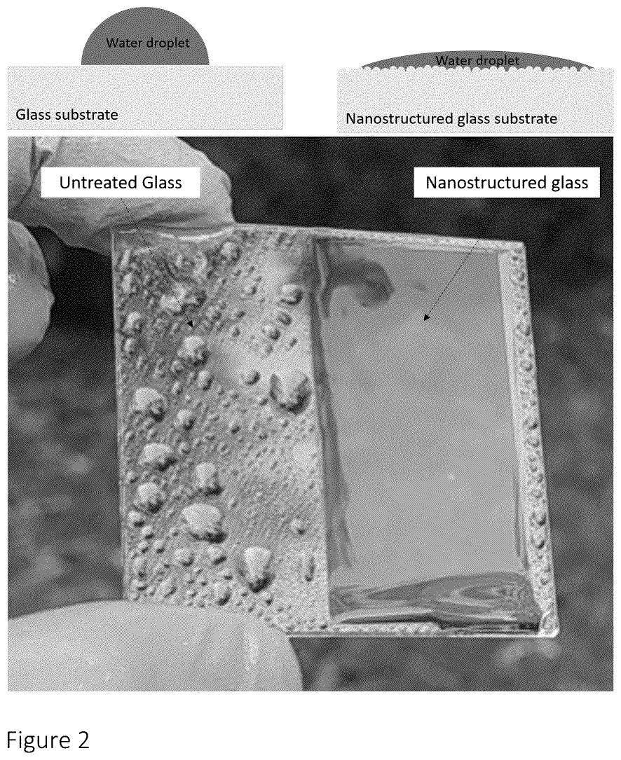

FIG. 2 presents an actual image with a characteristic example of the anti-fogging effects caused from the laser nano-structuring with either method 1 or 2 mentioned above. The schematics are realistic illustrations of a water droplet in contact with the surface of bare glass and laser nano-structured glass. The photograph below illustrates the surface response of a half laser treated (right side) fused silica glass under water mist spaying conditions. Note that the wettability may slightly vary depending on the glass type. However, the laser nano-structuring has always the same effect.

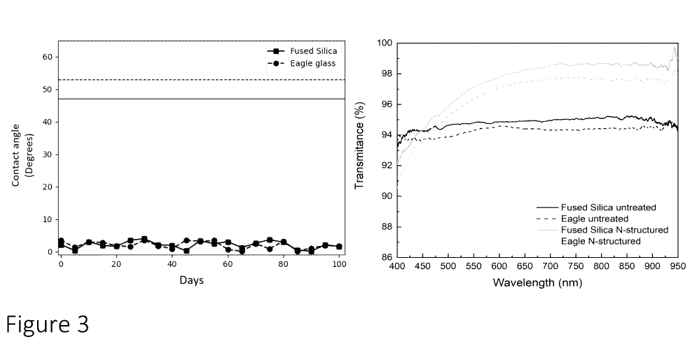

FIG. 3 Plotted diagrams with wetting response on the left for bare fused silica and Eagle glass substrates and laser nanostructured surfaces for both glass cases. The contact angle measurements were performed for 100 days with distilled water where 2 μl water droplets were used, and the samples were stored in room temperature between measurements. It is evident that for each glass examples the water contact significantly decreases after the laser nano-structuring as it is below 10 degrees for 100 days of measurement. As explained in the main text the remarkable superhydrophilicity is exactly the reason why the nanostructured surface attains anti-fogging properties under extreme humid environment. Furthermore, the transmittance of the same glass surfaces that exhibit anti-fogging properties is not decreased but enhanced, if not in the whole part of the visible spectrum but for most of it. The exact transmittance values are presented in the diagram on the right.

We claim:

1. A method of shaping a surface of a transparent solid material in the visible optical spectrum to increase hydrophilicity without affecting its optical transmissivity, comprising:
providing the transparent solid material on a holder;
identifying a desired target nanostructure anti-fogging pattern on the surface of the transparent solid material;
identifying a desired focused laser spot area on the surface of the transparent solid material;
selecting a laser fluence value from a range of laser fluence values;
selecting a wavelength, a repetition rate and a pulse duration of a laser pulse from a range of wavelengths, repetition rates and pulse durations, respectively;
exposing the surface of the transparent solid material to a focused laser radiation with the selected wavelength, repetition rate, pulse duration and generating at least part of the desired target nanostructure pattern;
relatively translating the transparent solid material with the laser beam to generate the desired nanostructure pattern by passing the laser beam over the surface of the transparent solid material.

2. The method according to claim 1, wherein an additional material layer is present on the top of the transparent solid material in the visible optical spectrum.

3. The method according to claim 1, further comprising:
scanning the laser beam on a stationary transparent solid material.

4. The method according to claim 1, wherein the transparent solid material comprises at least a glass or crystal piece.

5. The method according to claim 1, wherein the transparent solid material comprises at least a plastic or polymeric piece.

6. The method according to claim 5, wherein shaping the transparent solid material comprises shaping a glass piece on an electronic device, the electronic device including a solar cell (SC), an automotive display, a screen, a light emitting diode (LED) and a light detection and ranging (LIDAR) sensor.

7. The method according to claim 1, wherein the wavelength is selected from a range of 100 nm to 6100 nm.

8. The method according to claim 1, wherein the pulse duration is selected up to 800 ps.

9. The method according to claim 1, wherein the laser fluence is selected from a range of 12 J/cm² to 0.2 J/cm².

10. A manufacturing configuration to shape a surface of a transparent solid material to increase hydrophilicity without affecting its optical transmissivity, comprising:
an irradiation module having a pulsed laser source, an optical system for focusing a laser beam from the pulsed laser source, and a translation module comprising a holder configured to hold steady or translate the transparent solid material;
a controller to set a laser fluence value from a range of laser fluence values, set a laser pulse wavelength, a laser pulse repetition rate and a laser pulse duration from a range of laser pulse wavelengths, repetition rates and durations, respectively, and set a relative translation sequence between the transparent solid material and the laser beam during laser beam exposure with a laser beam from the pulsed laser source, in order to generate a desired nanostructure anti-fogging pattern.

11. The manufacturing configuration according to claim 10, wherein the optical system comprises at least a mirror to direct the laser beam from the pulsed laser source to the transparent solid material and at least a focusing optic to concentrate the laser beam on the transparent solid material.

12. The manufacturing configuration according to claim 10, wherein the pulsed laser source is a picosecond or a femtosecond laser source.

13. The manufacturing configuration according to claim 10, wherein the translation module is configured to displace the transparent material holder while the irradiation module remains stationary, and/or to displace the laser beam while the transparent material holder remains stationary and/or to displace the irradiation module while the transparent material holder remains stationary.

14-17. (canceled)

20. The computer program according to claim 10, stored in a computer-readable medium.

21. The computer program product according to claim 10, carried on a carrier signal.

22. The device incorporating an antifogging transparent solid material in the visible spectra fabricated according to claim 1.
